(19) United States
(12) Patent Application Publication
(10) Pub. No.: US 2017/0139583 A1
(43) Pub. Date: May 18, 2017

(54) METHOD AND DEVICE FOR CONTROLLING MOBILE TERMINAL

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yang Liu, Beijing (CN)

(21) Appl. No.: 15/245,034

(22) Filed: Aug. 23, 2016

Related U.S. Application Data
(63) Continuation of application No. PCT/CN2016/087057, filed on Jun. 24, 2016.

(30) Foreign Application Priority Data
Nov. 18, 2015 (CN) 201510801740.X

(51) Int. Cl. G06F 3/0488; G06F 3/0484; G06F 3/0354

(52) U.S. Cl. CPC G06F 3/04883; G06F 3/03547; G06F 3/04845

(57) ABSTRACT

An embodiment of the present disclosure discloses a method and device for controlling a mobile terminal. The method includes: acquiring control data which is generated when a user operates on a control component in the mobile terminal; converting the control data into a corresponding screen control instruction; and executing a control operation which is indicated by the screen control instruction on a currently displayed application page on a screen of the mobile terminal. According to the present disclosure, a control operation on a display page on the screen of the mobile terminal can be realized through an operation on the control component, and the touch control operation on the screen is not required anymore. When the control component is operated, the user's line of sight will not be blocked, so that the user's requirements for simple, easy and quick operations can be met, and the user's experience can be improved.

### CROSS-REFERENCE TO RELATED APPLICATIONS

This application is a continuation of International Application No. PCT/CN2016/087057, with an international filing date of filed Jun. 24, 2016, which is based upon and claims priority to Chinese Patent Application No. CN201510801740.X, entitled “METHOD AND DEVICE FOR CONTROLLING MOBILE TERMINAL”, filed on Nov. 18, 2015, the entire contents of all of which are incorporated herein by reference.

### TECHNICAL FIELD

The present disclosure generally relates to the technical field of mobile terminals, in particular to a method and device for controlling a mobile terminal.

### BACKGROUND

With the rapid development of mobile terminals, mobile terminals provide users many facilitating conditions and have become essential means of communication in people's lives and work due to increasingly rich varieties and increasingly powerful functions, and the users ask for higher and higher user experience of mobile terminals. At present, smart mobile terminals with large screens and capacitive touch screens have become more and more popular among the majority of users due to their independent operating systems as well as powerful and practical functions, and moreover the users can install various applications by themselves to realize function expansion.

In the prior art, when the users use the smart mobile terminals with touch screens, touch screen operations are mainly carried out by touching screen with the finger. However, using fingers to touch and control screens blocks users' line of sight. For example, user's fingers need to slide or pull on the screen to browse some pages with longer content, while the fingers will block users' sightlines in the process. Therefore, methods for controlling the mobile terminals in the prior art lead to poor user experience and cannot meet requirements of the users for easy, simple and quick operations.

### SUMMARY

An embodiment of the present disclosure discloses a method and device for controlling a mobile terminal in order to solve the problems of poor user experience and incapability of meeting requirements of users for easy, simple and quick operations caused by methods for controlling mobile terminals in the prior art.

According to one aspect of the present disclosure, an embodiment of the present disclosure provides a method for controlling a mobile terminal, the method including the following steps:

acquiring control data which is generated when a user operates on a control component in the mobile terminal;

converting the control data into a corresponding screen control instruction; and

executing a control operation which is indicated by the screen control instruction on a currently displayed application page on the screen of the mobile terminal.

According to another aspect of the present disclosure, an embodiment of the present disclosure provides a mobile terminal, including: at least one processor; and a memory communicably connected with the at least one processor and for storing instructions executable by the at least one processor,

wherein execution of the instructions by the at least one processor causes the at least one processor to:

acquire control data which is generated when a user operates on a control component in the mobile terminal;

convert the control data into a corresponding screen control instruction; and

execute a control operation which is indicated by the screen control instruction on a currently displayed application page on the screen of the mobile terminal.

According to a further aspect of the present disclosure, there is disclosed a computing device including: one or more processors; a memory and one or more modules, the modules are stored in the memory and are configured to be processed by one or more processors, wherein the modules are configured to execute the methods in the embodiment of the present disclosure.

According to another further aspect of the present disclosure, there is disclosed a computer readable medium, which stores the computer program for executing the methods above.

The present disclosure has the following beneficial effects:

according to the method and device for controlling the mobile terminal provided by the embodiment of the present disclosure, as the control component is included in the mobile terminal, the control data which is generated when the user operates the control component can be acquired by the control component, the mobile terminal converts the control data into a corresponding screen control instruction after acquiring the control data, and a control operation which is indicated by the screen control instruction is executed on the currently displayed application page on the screen of the mobile terminal. Therefore, according to the embodiment of the present disclosure, a control operation on a display page on the screen of the mobile terminal can be realized through an operation on the control component, and therefore the touch control operation on the screen is not required anymore. When the control component is operated, the user's line of sight will not be blocked, so that user requirements for simple, easy and quick operations can be met, and users' experience can be improved.

The above description is only a summary of the technical solution of the present disclosure. In order to clearly illustrate the technical means of the present disclosure to ensure the present disclosure is implementable according to content of the specifications, and in order to make the above and other purposes, characteristics and advantages of the present disclosure more apparent to understand, embodiments of the present disclosure are specifically illustrated as follows.

### BRIEF DESCRIPTION OF THE DRAWINGS

In order to clearly illustrate the technical solution of the embodiments of the present disclosure or in the prior art, the drawings which are required for the description in the embodiments or in the prior art will be briefly described in the following; it is obvious that the described drawings are only related to some embodiments of the present disclosure. And based on the described drawings herein, those skilled in the art can obtain other drawings without any inventive work.

FIG. 1 is a steps flow chart of a method for controlling a mobile terminal according to a first embodiment of the present disclosure.

FIG. 2 is a steps flow chart of a method for controlling a mobile terminal according to a second embodiment of the present disclosure.

FIG. 3 is a schematic diagram of a correspondence relationship of control data and screen controlling gesture according to the second embodiment of the present disclosure.

FIG. 4 is a structure block diagram of a device for controlling a mobile terminal according to a third embodiment of the present disclosure.

FIG. 5 is a structure block diagram of a device for controlling a mobile terminal according to a fourth embodiment of the present disclosure.

FIG. 6 schematically illustrates a block diagram of a mobile terminal used to execute the method according to the present disclosure.

FIG. 7 schematically illustrates a storage cell used to keep or carry a program code for realizing the method according to the present disclosure.

### DESCRIPTION OF THE EMBODIMENTS

In order to make the objects, technical solutions and advantages of the embodiments of the present disclosure apparent, the technical solutions in the embodiments of the present disclosure will be described in a clear and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s) without any inventive work, which should be within the scope of the present disclosure.

### First Embodiment

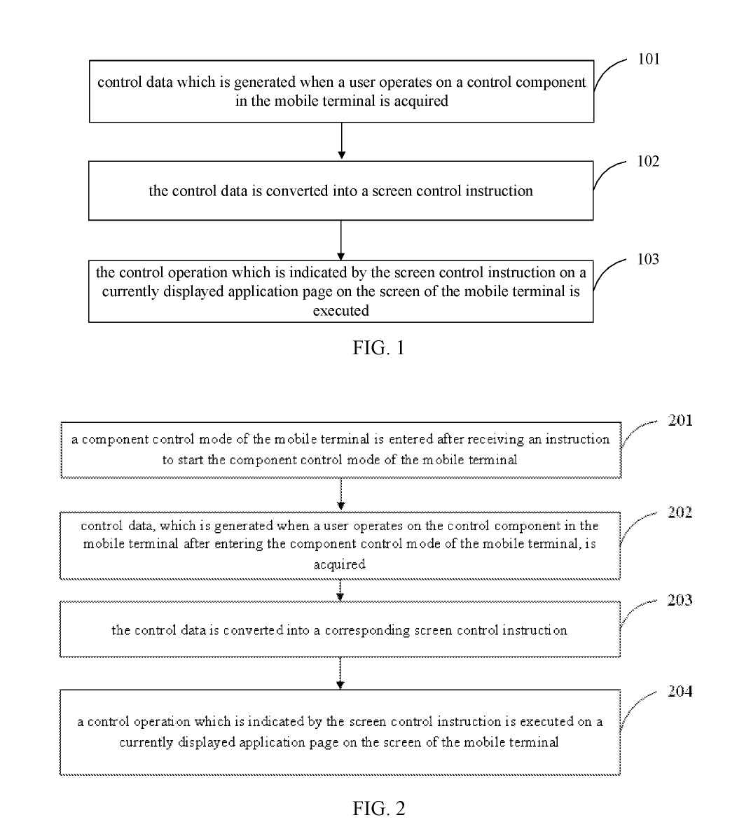

With reference to FIG. 1, it is illustrated a steps flow chart of a method for controlling a mobile terminal according to a first embodiment of the present disclosure.

According to the embodiment of the present disclosure, the method for controlling the mobile terminal may include the following steps.

In step 101, control data which is generated when a user operates on a control component in the mobile terminal is acquired.

According to the embodiment of the present disclosure, the mobile terminal may be but not limited to a mobile phone, a tablet computer, a notebook and the like with a touch screen.

A control component is arranged in the mobile terminal. The embodiment of the present disclosure aims at realizing a control operation on a display page on a screen of the mobile terminal through an operation on the control component in the mobile terminal so as to avoid blocking the user's line of sight during the touch control operation on the screen. A user can operate on the control component in the mobile terminal, and corresponding control data can be generated during the operation process; for example, corresponding sliding data (such as sliding direction and the like) can be generated during a sliding operation, and corresponding pulling data (such as pulling direction, pulling distance and the like) can be generated during a pulling operation. The control data is collected by the control component, and a system of the mobile terminal can acquire the control data which is collected by the control component, and execute subsequent processes according to the control data.

In step 102, the control data is converted into a screen control instruction.

As it is required to control the page which is displayed on the screen of the mobile terminal according to the control data, the system can convert the control data into the corresponding screen control instruction after the control data is acquired, where the screen control instruction is an instruction to realize a control operation on a currently displayed page on the screen of the mobile terminal. The detailed conversion process will be described in the second embodiment herein below.

In step 103, the control operation which is indicated by the screen control instruction on a currently displayed application page on the screen of the mobile terminal is executed.

The screen control instruction which is obtained through the conversion indicates the control operation which is required for the currently displayed application page on the screen of the mobile terminal, and therefore a corresponding control operation can be executed on the currently displayed application page on the screen according to the screen control instruction so as to achieve the purpose of controlling the application page without touching the screen. The detailed process for such step will be described in the second embodiment herein below.

According to the method for controlling the mobile terminal provided by the embodiment of the present disclosure, as the control component is included in the mobile terminal, the control data which is generated when the user operates on the control component can be collected by the control component. The mobile terminal converts the control data into a corresponding screen control instruction after acquiring the control data, and the control operation which is indicated by the screen control instruction is executed on the currently displayed application page on the screen of the mobile terminal. Therefore, according to the embodiment of the present disclosure, the control operation on a display page on the screen of the mobile terminal can be realized through the operation on the control component, and therefore the touch control operation on the screen is not required any more. When the control component is operated, the user's line of sight will not be blocked, so that requirements of users for simple, easy and quick operations can be met, and the user's experience can be improved.

### Second Embodiment

With reference to FIG. 2, it is illustrated a steps flow chart of a method for controlling a mobile terminal according to a second embodiment of the present disclosure.

According to the embodiment of the present disclosure, a method for controlling a mobile terminal may include the following steps.

In step 201, a component control mode of the mobile terminal is entered after receiving an instruction to start the component control mode of the mobile terminal.

Optionally, according to the embodiment of the present disclosure, the component control mode of the mobile terminal can be set in advance, wherein the component control mode refers to a mode to control a currently displayed page on a screen of the mobile terminal through the control component. A startup option and a closedown option can be set to correspond to the component control mode; for example, a startup button and a closedown button can be set. When it is selected to start the component control mode of the mobile terminal, a system can receive an instruction to start the component control mode of the mobile terminal, enter the component control mode of the mobile terminal after receiving the instruction, and allow a control operation on the displayed page on the screen through an operation on the control component after entering the component control mode; when it is selected to close the component control mode of the mobile terminal, the system can receive an instruction to close the component control mode of the mobile terminal, exit the component control mode of the mobile terminal after receiving the instruction, and does not allow the control operation on the displayed page on the screen through the operation on the control component any more after exiting the component control mode.

In step 202, control data, which is generated when a user operates on the control component in the mobile terminal after entering the component control mode of the mobile terminal, is acquired.

According to the embodiment of the present disclosure, the control component may be an original fingerprint identification component in the mobile terminal. Through expanding functions of the fingerprint identification component, the user's operations on the control component other than an operation of inputting a fingerprint password can be identified. The control component may also be a touch identifier which is installed in the mobile terminal in advance. The touch identifier can be installed at a place where the user can execute a touch operation on the touch identifier conveniently, such as on a blank panel of the mobile terminal. Of course, the control component may also be the combination of both the fingerprint identification component and the touch identifier. There is no limit to the control component in embodiments of the present disclosure.

When the user operates on the control component, the control data corresponding to the operation can be generated. For example, the user's operation on the control component may also include a sliding operation (namely the user slides their finger on the control component once), and the control data which is generated during the sliding operation includes sliding data, wherein the sliding data includes a sliding direction, such as a vertical up direction, a vertical down direction, a horizontal left direction and a horizontal right direction. For another example, the user's operation on the control component may include a pulling operation (namely the user holds and pulls on the control component from a starting point to an end point), and the control data which is generated during the pulling operation includes pulling data, wherein the pulling data includes a pulling direction and a pulling distance. The pulling direction may include any direction which form an included angle from 0 degree to 360 degrees with the horizontal right x-axis, and the pulling distance refers to a linear distance from the starting point to the end point.

The control component can collect the generated control data, and the system of the mobile terminal acquires the control data which is collected by the control component. Optionally, the process of acquiring the control data may include the following conditions: the control component automatically sends the control data to the system after collecting the control data; or the system detects whether the control component has collected the control data, and actively acquires the control data when it is detected that the control component has collected the control data. There is no limit to the process of acquiring the control data in embodiments of the present disclosure.

In step 203, the control data is converted into a corresponding screen control instruction.

Optionally, the step 203 may include the following sub-steps.

In sub-step a1, a screen control gesture corresponding to the control data is determined from a preset correspondence of control data and screen control gestures.

According to the embodiment, the correspondence of the control data and the screen control gestures can be set in advance. Since the control data and the screen control gestures corresponding to the control data are included in the correspondence, the screen control gesture which corresponds to the above acquired control data can be determined from the correspondence.

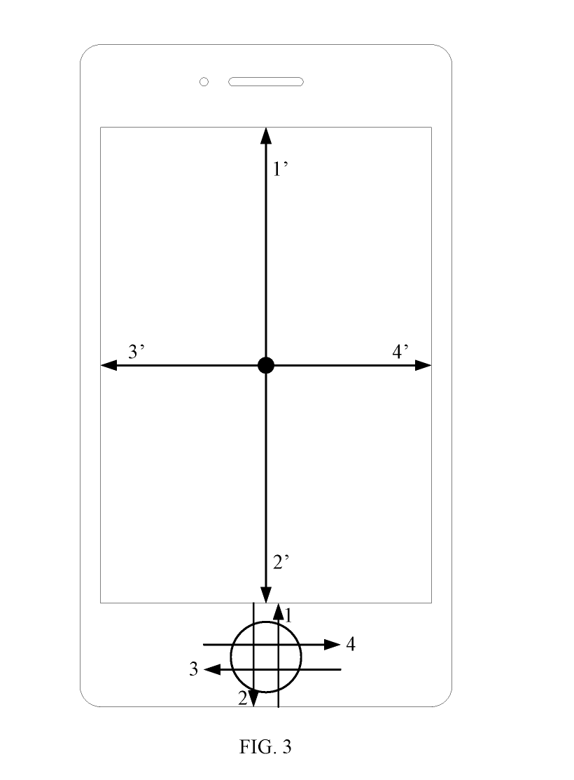

With reference to FIG. 3, it is illustrated a schematic diagram of a correspondence of the control data and the screen controlling gesture according to the second embodiment of the present disclosure, and the following descriptions take as examples that the control component is the fingerprint identification component and the control data is the sliding data (sliding direction) in combination with FIG. 3. According to FIG. 3, when the sliding data (sliding direction) is vertical up (the arrow marked with 1), the corresponding screen control gesture is up, starting from a central point of the screen and ending at the top of the screen, and the sliding direction is in the vertical up direction (the arrow marked with 1′); when the sliding data (sliding direction) is vertical down (the arrow marked with 2), the corresponding screen control gesture is down, starting from the central point of the screen and ending at the bottom of the screen, and the sliding direction is in the vertical down direction (the arrow marked with 2′); when the sliding data (sliding direction) is horizontal left (the arrow marked with 3), the corresponding screen control gesture is left, starting from the central point of the screen and ending at the left end of the screen, and the sliding direction is in the horizontal left direction (the arrow marked with 3′); and when the sliding data (sliding direction) is horizontal right (the arrow marked with 4), the corresponding screen control gesture is right, starting from the central point of the screen and ending at the right end of the screen, and the sliding direction is in the horizontal right direction (the arrow marked with 4′).

The description on the above four screen control gestures which are illustrated in FIG. 3 is shown in table 1 as follows:

TABLE 1

| Gesture | Starting point | Ending point | Sliding direction |
|---|---|---|---|
| Up | Central point of screen | Top of screen | Vertical up |
| Down | Central point of screen | Bottom of screen | Vertical down |
| Left | Central point of screen | Left end of screen | Horizontal left |
| Right | Central point of screen | Right end of screen | Horizontal right |

It should be noted that the screen control gestures described above are illustrative only, and they can serve as the system's default screen control gestures. Of course, those skilled in the art may further define corresponding screen control gestures according to actual conditions, and there is no limit to the screen control gestures in embodiments of the present disclosure.

In sub-step a2, a screen control instruction corresponding to the screen control gesture is generated, wherein the generated screen control instruction serves as the screen control instruction which corresponds to the control data.

The screen control gesture is analogous to gesture data which is generated during the user's touch operations on the screen; the system may generate the screen control instruction corresponding to the screen control gesture; the screen control instruction is used to indicate a control operation on the displayed page on the screen; and the generated screen control instruction is the screen control instruction corresponding to the control data.

For example, the control data includes sliding data, and the sliding data includes a sliding direction. The screen control instruction corresponding to such control data includes an instruction to slide along the sliding direction. Specifically, when the sliding direction is in the vertical up direction, the screen control instruction is an instruction to slide along the vertical up direction; when the sliding direction is in the vertical down direction, the screen control instruction is an instruction to slide along the vertical down direction; when the sliding direction is in the horizontal left direction, the screen control instruction is an instruction to slide along the horizontal left direction; and when the sliding direction is in the horizontal right direction, the screen control instruction is an instruction to slide along the horizontal right direction. For another example, the control data includes pulling data, and the pulling data includes a pulling direction and a pulling distance. The screen control instruction corresponding to the control data includes an instruction to pull for the above pulling distance along the above pulling direction. For example, when the pulling direction is the direction which forms an included angle of 60 degrees with the horizontal right x-axis, and the pulling distance is 1 cm, the screen control instruction is an instruction to pull for 1 cm along the direction which forms the included angle of 60 degrees with the horizontal right x-axis, etc.

In step 204, a control operation which is indicated by the screen control instruction is executed on a currently displayed application page on the screen of the mobile terminal.

According to the above screen control instruction, the control operation which is indicated by the screen control instruction can be executed on the currently displayed application page on the screen.

If the control data includes a sliding direction, the screen control instruction corresponding to the control data includes an instruction to slide along the sliding direction. The step 204 includes the step of sliding the currently displayed application page on the screen of the mobile terminal for a distance of one page along the sliding direction. Taking for an example that the currently displayed application page on the screen is a book page, when a horizontal left sliding operation is executed on the control component, the generated control data is that the sliding direction is in the horizontal left direction, the screen control instruction corresponding to the control data is an instruction to slide along the horizontal left direction, and accordingly the control operation on the currently displayed book page is to slide left on the book page for the distance of one page, namely an operation of turning to the next page. As for other sliding directions, those skilled in the art can conduct corresponding processes with reference to the above description, which will not be described in detail in embodiments of the present disclosure.

If the control data includes a pulling direction and a pulling distance, the screen control instruction corresponding to the control data includes an instruction to pull for the above pulling distance along the above pulling direction. The step 204 includes the step of pulling the currently displayed application page on the screen of the mobile terminal for the above pulling distance along the above pulling direction. Taking for example that the currently displayed application page on the screen is an amplified photo page, when a pulling operation of pulling for 1 cm along the direction which forms an included angle of 90 degrees with the horizontal right x-axis is executed on the control component, the generated control data is that the pulling direction is the direction which forms the included angle of 90 degrees with the horizontal right x-axis and the pulling distance is 1 cm, the screen control instruction corresponding to the control data is to pull for 1 cm along the direction which forms the included angle of 90 degrees with the horizontal right x-axis, and accordingly the control operation on the currently displayed photo page is to pull the photo page for 1 cm along the direction which forms the included angle of 90 degrees with the horizontal right x-axis, namely an operation of pulling for 1 cm along the vertical up direction. As for other pulling directions and pulling distances, those skilled in the art can conduct corresponding processes with reference to the above description, which will not be described in detail in embodiments of the present disclosure.

According to the embodiment of the present disclosure, a convenient man-machine interaction mode is increased. The displayed page on the screen is controlled indirectly through the user's operation on the control component, so that the operation of scrolling a view without blocking line of sight is realized, and the user's experience is improved.

With respect to the embodiments of the above methods, in order to realize brief description, the methods are described as the combination of a series of actions. However, it should be known to those skilled in the art that the present disclosure is not subjected to the order of the described actions, as some steps can employ other orders or can be executed at the same time according to the present disclosure. Moreover, it should be known to those skilled in the art that the embodiments described in the specification all belong to optional embodiments and associated actions and modules are not necessarily required in the present disclosure.

### Third Embodiment

With reference to FIG. 4, it is illustrated a structure block diagram of a device for controlling a mobile terminal according to a third embodiment of the present disclosure.

According to the embodiment of the present disclosure, the device for controlling the mobile terminal may include the following modules:

an acquisition module 401 is configured to acquire control data which is generated when a user operates on a control component in the mobile terminal;

a conversion module 402 is configured to convert the control data into a corresponding screen control instruction; and

a control module 403 is configured to execute a control operation which is indicated by the screen control instruction on a currently displayed application page on a screen of the mobile terminal.

According to the device for controlling the mobile terminal provided by the embodiment of the present disclosure, as the control component is included in the mobile terminal, the control data which is generated when the user operates on the control component can be acquired by the control component. The mobile terminal converts the control data into a corresponding screen control instruction after acquiring the control data, and the control operation which is indicated by the screen control instruction is executed on the currently displayed application page on the screen of the mobile terminal. Therefore, according to the embodiment of the present disclosure, the control operation on a display page on the screen of the mobile terminal can be realized through an operation on the control component, and the touch control operation on the screen is not required any more. When the control component is operated, the user's line of sight will not be blocked, so that the requirements of the user for simple, easy and quick operations can be met, and the user's experience can be improved.

### Fourth Embodiment

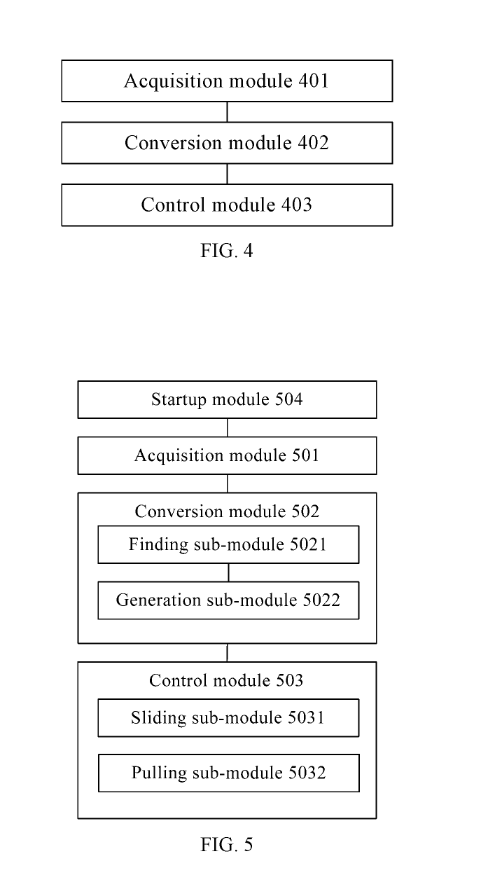

With reference to FIG. 5, it is illustrated a structure block diagram of a device for controlling a mobile terminal according to a fourth embodiment of the present disclosure.

According to the embodiment of the present disclosure, the device for controlling the mobile terminal may include the following modules:

an acquisition module 501 is configured to acquire control data which is generated when a user operates on a control component in the mobile terminal;

a conversion module 502 is configured to convert the control data into a corresponding screen control instruction; and

a control module 503 is configured to execute a control operation which is indicated by the screen control instruction on a currently displayed application page on a screen of the mobile terminal.

Optionally, the conversion module 502 includes a determining sub-module 5021 which is configured to determine a screen control gesture corresponding to the control data from a preset correspondence of the control data and the screen control gesture; and a generation sub-module 5022 which is configured to generate the screen control instruction corresponding to the screen control gesture, wherein the generated screen control instruction serves as the screen control instruction corresponding to the control data.

Optionally, if the control data includes a sliding direction, the screen control instruction corresponding to the control data includes an instruction to slide along the sliding direction. The control module 503 includes a sliding sub-module 5031 which is configured to slide the currently displayed application page on the screen of the mobile terminal for a distance of one page along the sliding direction.

Optionally, if the control data includes a pulling direction and a pulling distance, the screen control instruction corresponding to the control data includes an instruction to pull for the above pulling distance along the above pulling direction. The control module 503 includes a pulling sub-module 5032 which is configured to pull the currently displayed application page on the screen of the mobile terminal for the above pulling distance along the above pulling direction.

Optionally, according to the embodiment of the present disclosure, the device for controlling the mobile terminal further includes a startup module 504 which is configured to enter a component control mode of the mobile terminal after receiving an instruction to start the component control mode of the mobile terminal. Correspondingly, the acquisition module is specifically configured to acquire the control data which is generated when the user operates on the control component in the mobile terminal after entering the component control mode of the mobile terminal.

Optionally, the control component includes an original fingerprint identification component in the mobile terminal and/or a touch identifier which is installed in the mobile terminal in advance.

According to the embodiment of the present disclosure, a convenient man-machine interaction mode is increased. The displayed page on the screen is controlled indirectly through the user's operation on the control component, so that the operation of scrolling a view without blocking the line of sight is realized, and the user's experience is improved.

Device embodiments are briefly described herein as they are substantially similar to method embodiments; please refer to the description of the method embodiments for associated parts.

Device embodiments described above are illustrative only, wherein the unit described as a separate part may be or may not be physically separated, a part displayed as the unit may be or may not be a physical unit, may be located in one place, or may be distributed on a plurality of network units. Some or all of the modules may be selected to achieve the objective of the solutions of the embodiments according to actual requirements. Those ordinarily skilled in the art may understand and implement it without paying creative works.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

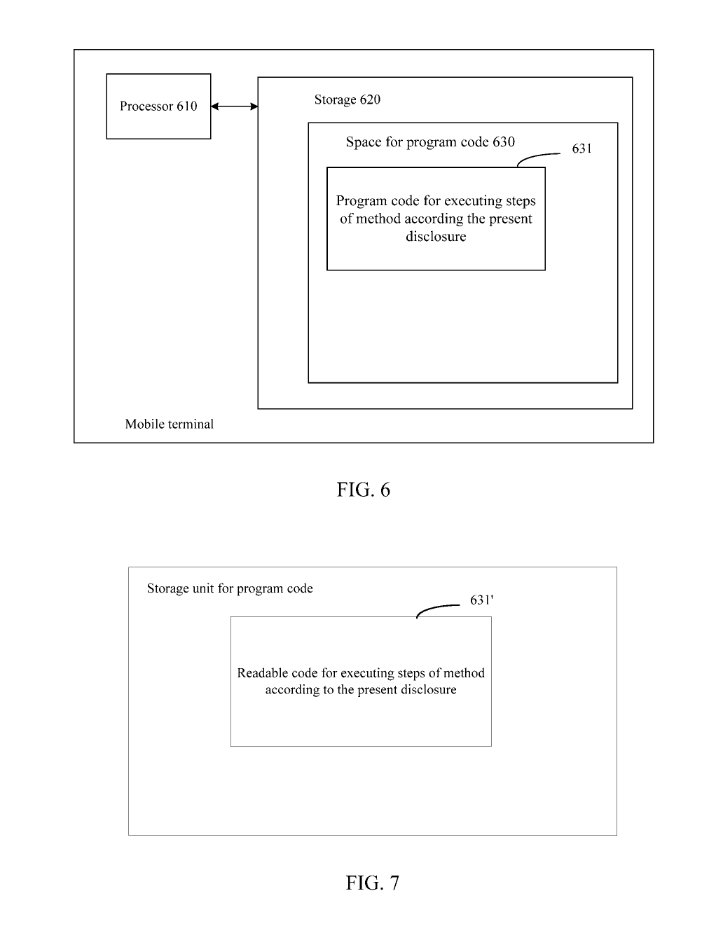

For example, FIG. 6 illustrates a block diagram of a mobile terminal for executing the method according the disclosure. Traditionally, the mobile terminal includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed for example in an appropriate form. Usually, the memory cell includes computer readable codes 631′ which can be read for example by processors 610. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that the foregoing embodiments are merely illustrative of technical solutions of the present disclosure without limitation; although the present disclosure is illustrated in detail with reference to the above embodiments, those ordinarily skilled in the art will appreciate that modifications may be made to the technical solutions cited by the above embodiments, or equivalent substitutions may be made to partial technical features; moreover, these modifications or substitutions will not make the essential of corresponding technical solutions depart from the spirit and scope of the technical solutions in respective embodiments of the present disclosure.

What is claimed is:

1. A method for controlling a mobile terminal, comprising:
acquiring control data which is generated when a user operates on a control component in the mobile terminal;
converting the control data into a corresponding screen control instruction; and
executing a control operation which is indicated by the screen control instruction on a currently displayed application page on the screen of the mobile terminal.

2. The method according to claim 1, wherein converting the control data into the corresponding screen control instruction comprises:
determining a screen control gesture corresponding to the control data from a preset correspondence of control data and screen control gestures; and
generating a screen control instruction corresponding to the screen control gesture, as the screen control instruction which corresponds to the control data.

3. The method according to claim 1, wherein the control data comprises a sliding direction, the screen control instruction corresponding to the control data comprises an instruction to slide along the sliding direction; and
executing a control operation which is indicated by the screen control instruction on the currently displayed application page on the screen of the mobile terminal comprises:
sliding the currently displayed application page on the screen of the mobile terminal for a distance of one page along the sliding direction.

4. The method according to claim 1, wherein the control data comprises a pulling direction and a pulling distance, the screen control instruction corresponding to the control data comprises an instruction to pull for the above pulling distance along the above pulling direction; and
executing a control operation which is indicated by the screen control instruction on the currently displayed application page on the screen of the mobile terminal comprises:
pulling the currently displayed application page on the screen of the mobile terminal for the above pulling distance along the above pulling direction.

5. The method according to claim 1, wherein before acquiring the control data which is generated when the user operates on the control component in the mobile terminal, the method further comprises:
entering a component control mode of the mobile terminal after receiving an instruction to start the component control mode of the mobile terminal; and
acquiring the control data which is generated when the user operates on the control component in the mobile terminal comprises:
acquiring the control data which is generated when the user operates on the control component in the mobile terminal after entering the component control mode of the mobile terminal.

6. The method according to claim 1, wherein the control component comprises an original fingerprint identification component in the mobile terminal and/or a touch identifier which is installed in the mobile terminal in advance.

7. A mobile terminal, comprising:
at least one processor; and
a memory communicably connected with the at least one processor and for storing instructions executable by the at least one processor,
wherein execution of the instructions by the at least one processor causes the at least one processor to:
acquire control data which is generated when a user operates on a control component in the mobile terminal;
convert the control data into a corresponding screen control instruction; and
execute a control operation which is indicated by the screen control instruction on a currently displayed application page on the screen of the mobile terminal.

8. The mobile terminal according to claim 7, wherein converting the control data into a corresponding screen control instruction comprises:
determining a screen control gesture corresponding to the control data from a preset correspondence of the control data and the screen control gesture; and
generating the screen control instruction corresponding to the screen control gesture, as the screen control instruction corresponding to the control data.

9. The mobile terminal according to claim 7, wherein the control data comprises a sliding direction, the screen control instruction corresponding to the control data comprises an instruction to slide along the sliding direction; and
executing a control operation which is indicated by the screen control instruction on a currently displayed application page on the screen of the mobile terminal comprises:
sliding the currently displayed application page on the screen of the mobile terminal for a distance of one page along the sliding direction.

10. The mobile terminal according to claim 7, wherein the control data comprises a pulling direction and a pulling distance, the screen control instruction corresponding to the control data comprises an instruction to pull for the above pulling distance along the above pulling direction; and
executing a control operation which is indicated by the screen control instruction on a currently displayed application page on the screen of the mobile terminal comprises:
pulling the currently displayed application page on the screen of the mobile terminal for the above pulling distance along the above pulling direction.

11. The mobile terminal according to claim 7, wherein execution of the instructions by the at least one processor causes the at least one processor further to:
enter a component control mode of the mobile terminal after receiving an instruction to start the component control mode of the mobile terminal;
acquire the control data which is generated when the user operates on the control component in the mobile terminal after entering the component control mode of the mobile terminal.

12. The mobile terminal according to claim 7, wherein the control component comprises an original fingerprint identification component in the mobile terminal and/or a touch identifier which is installed in the mobile terminal in advance.

13. A non-transitory computer readable storage medium having computer programs stored thereon that, when executed by one or more processors of an electronic device, cause the electronic device to perform:
acquiring control data which is generated when a user operates on a control component in the mobile terminal;
converting the control data into a corresponding screen control instruction; and
executing a control operation which is indicated by the screen control instruction on a currently displayed application page in a screen of the mobile terminal.

14. The non-transitory computer readable storage medium according to claim 13, wherein converting the control data into the corresponding screen control instruction comprises:
determining a screen control gesture corresponding to the control data from a preset correspondence of control data and screen control gestures; and
generating a screen control instruction corresponding to the screen control gesture, as the screen control instruction which corresponds to the control data.

15. The non-transitory computer readable storage medium according to claim 13, wherein the control data comprises a sliding direction, the screen control instruction corresponding to the control data comprises an instruction to slide along the sliding direction; and
executing a control operation which is indicated by the screen control instruction on the currently displayed application page on the screen of the mobile terminal comprises:
sliding the currently displayed application page on the screen of the mobile terminal for a distance of one page along the sliding direction.

16. The non-transitory computer readable storage medium according to claim 13, wherein the control data comprises a pulling direction and a pulling distance, the screen control instruction corresponding to the control data comprises an instruction to pull for the above pulling distance along the above pulling direction; and
executing a control operation which is indicated by the screen control instruction on the currently displayed application page on the screen of the mobile terminal comprises:
pulling the currently displayed application page on the screen of the mobile terminal for the above pulling distance along the above pulling direction.

17. The non-transitory computer readable storage medium according to claim 13, wherein before acquiring the control data which is generated when the user operates on the control component in the mobile terminal, the electronic device further performs:
entering a component control mode of the mobile terminal after receiving an instruction to start the component control mode of the mobile terminal; and
acquiring the control data which is generated when the user operates on the control component in the mobile terminal comprises:
acquiring the control data which is generated when the user operates on the control component in the mobile terminal after entering the component control mode of the mobile terminal.

18. The non-transitory computer readable storage medium according to claim 13, wherein the control component comprises an original fingerprint identification component in the mobile terminal and/or a touch identifier which is installed in the mobile terminal in advance.
